SEQUENCE LISTING (1 sequence)

SEQ ID NO: 1 - protein, 11 aa, Artificial Sequence
  Synthetic oligopeptide as a sugar acceptor substrate for constructing a glyocopeptide library
AHGVTSAPDTR

(19) United States
(12) Patent Application Publication
(10) Pub. No.: US 2006/0183155 A1
(43) Pub. Date: Aug. 17, 2006

(54) Compound libraries by glycotransferases and a method of preparing the same

(76) Inventors: Hiromi Ito, Tsukuba-shi (JP); Akihiko Kameyama, Tsukuba-shi (JP); Hisashi Narimatsu, Tsukuba-shi (JP)

Correspondence Address: NIXON & VANDERHYE, PC, 901 NORTH GLEBE ROAD, 11TH FLOOR, ARLINGTON, VA, 22203, US

(21) Appl. No.: 11/198,403

(22) Filed: Aug. 8, 2005

(30) Foreign Application Priority Data
Feb. 17, 2005 (JP) 2005-41383

(51) Int. Cl. C40B 40/02; C40B 40/10

(52) U.S. Cl. 435/7.1

(57) ABSTRACT

The present invention aims to provide processes for rapidly and easily preparing compound libraries of known structures, and compound libraries prepared by said processes. A compound library of the present invention is prepared by a process for preparing a compound library in the same vessel, comprising: (1) mixing one or more donor substrates, acceptor substrates, and transferases; (2) performing a transfer reaction to reach a degree of transfer of 1%-99% by incubating the mixture; and (3) stopping the transfer reaction.

### FILED OF THE INVENTION

The present invention relates to compound libraries rapidly and easily prepared in the same vessel using transferases and processes for preparing them.

### BACKGROUND OF THE INVENTION

In understanding sophisticated regulatory mechanisms of organisms, it is very important to investigate interactions between biological molecules and correlations between the structures and functions of biological molecules. Isolating nucleic acids or proteins expressed in only small amounts in tissues or cells of organisms and rapidly and conveniently identifying their sequence information or three-dimensional structures is an important challenge in the field of bioinformatics aiming to presume molecular functions from molecular structures or in the field of proteomics aiming to exhaustively analyze expressed proteins.

Biological molecules that control sophisticated regulatory mechanisms include glycoconjugates or the like in addition to nucleic acids, proteins, and peptides. For example, functions of proteins translated after gene expression in cells are regulated by various post-translational modifications such as activation by various proteases or activity regulation via glycosylation, sulfation, phosphorylation, acylation or the like by various transferases. It is also known that about 50% or more of biological proteins exist as complexes with oligosaccharides and that oligosaccharides play the role of controlling the structures and functions of glycoproteins. Moreover, the functions of oligosaccharides per se are also controlled by sulfation, phosphorylation, acylation, or addition of new glycosyl residues, as described above.

However, when one wishes to analyze the functions of modified proteins, peptides, oligosaccharides or the like, multiple modifications are frequently seen in the same molecule rather than uniform modification in each molecule. Thus, such non-uniformity of modified molecules makes it not only very difficult to closely analyze molecular interactions or correlations between the structures and functions of molecules, but also difficult to simultaneously obtain a plurality of target modified molecules in such studies.

At present, many physiologically active peptides are known. It is very important to investigate relationships between the amino acid sequences of such peptides and their physiological activity, but there are few examples of studies that went into details of physiological activity using post-translationally modified peptides observed in vivo. If a library of various modified peptides could be available in such studies, it would become possible not only to easily analyze the relationship between the amino acid sequence and physiological activity of a specific peptide by closely examining the physiological activity of the peptide obtained by screening, but also to search modified peptides having desired activity.

The same problem occurs in the field of study of glycoproteins and oligosaccharides, because oligosaccharide moieties also undergo various modifications, i.e. a wide variety of glycosyl residues are added to an acceptor substrate at specific times and specific locations by the action of multiple enzymes expressed in vivo, including enzymes responsible for oligosaccharide elongation such as glycosyltransferases, glycosidases and glycosylation enzymes or transferases required for sulfation, phosphorylation, acylation or the like as described above. It can be said that such modifications to oligosaccharides are important mechanisms as seen with protein phosphorylation cascades.

For example, oligosaccharides added to proteins are classified broadly into O-linked oligosaccharides attached to serine/threonine residues and N-linked oligosaccharides attached to asparagine residues of proteins or peptides, and exist as variations of oligosaccharide structures depending on the type, number and mode of linkage of glycosyl residues constituting the oligosaccharides. Such oligosaccharide structures are strictly controlled by the glycosyltransferases or the like described above during the expression of glycoproteins. Sulfation of oligosaccharides, which means the sulfotransferase-catalyzed transfer of a sulfate group from a sulfate donor, 3′-phosphoadenosine 5′-phosphosulfate (PAPS) to an acceptor substrate, has become known to be responsible for various biological phenomena. In this manner, there is a high possibility that the structural analysis of modified oligosaccharides or those oligosaccharides per se may be applied to biotechnology or medical field. However, it is difficult to obtain various oligosaccharides or oligosaccharide libraries for use in the study of oligosaccharides including analysis of the importance of modification of oligosaccharides because oligosaccharides are expressed in vivo in very small amounts.

Known methods for supplying oligosaccharides or oligosaccharide libraries include combinatorial chemical synthesis based on solid-phase synthesis (see Non-patent documents 1-4) and combinatorial chemical synthesis based on liquid-phase synthesis (see Non-patent documents 5-9).

Examples of combinatorial chemical syntheses based on solid or liquid phase include Split and Combine Library Synthesis, Parallel Synthesis of Compound arrays, and One-Pot Glycosylation as technically distinct approaches. However, these methods mainly use organic chemical synthesis and therefore inevitably require the step of protection/deprotection in each synthetic process because a suitable protective group must be introduced in advance into the hydroxyl group of the glycosyl donor substrate or glycosyl acceptor substrate to newly add a glycosyl residue to a specific site of an existing glycosyl residue. If an unprotected acceptor substrate was used (e.g., random glycosylation), the resulting product would include a lot of mixtures of steric isomers and position isomers and purification or structure determination thereof would be complex.

Conventional enzymatic or chemical-enzymatic synthesis uses a glycosyl acceptor substrate mainly prepared by chemical synthesis to perform glycosylation using glycosidase-catalyzed reverse reaction or glycosyltransferase-catalyzed sequential synthesis. For example, a basic process for synthesizing an oligosaccharide containing several glycosyl residues comprises mixing a glycosyl acceptor substrate, a glycosyl donor substrate, and a glycosyltransferase, recovering/purifying the product after the glycosyl transfer to the substrate has proceeded to 100%, and performing oligosaccharide elongation on said product by a transfer reaction using a different (or the same) glycosyltransferase as a glycosyl acceptor substrate for the subsequent reaction. However, such enzymatic synthesis requires complex steps including many reactions, recovery, and purification to obtain a desired oligosaccharide structure and also requires that separately prepared oligosaccharides should be gathered to construct an oligosaccharide library. Moreover, the oligosaccharide library contains very limited kinds of oligosaccharide structures because of the limitation of the kinds of glycosyltransferases commercially or otherwise available.

A known method for preparing an oligosaccharide library by cellular synthesis rather than organic synthesis is biocombinatorial synthesis (see Non-patent document 10). This method uses oligosaccharide primers mimicking the oligosaccharide structures serving as precursors in the oligosaccharide biosynthetic pathways as artificial substrates for glycosyltransferase reactions. Specifically, oligosaccharide primers are introduced into a cell so that various oligosaccharides can be obtained by oligosaccharide elongation using the oligosaccharide biosynthetic pathways of the cell. An oligosaccharide library is constructed by changing the combination of the oligosaccharide primers and cell used because the biosynthetic pathways vary with the cell type. However, various oligosaccharide-related enzymes such as glycosyltransferases are expressed in cells at different expression times and levels even if cell culture conditions slightly changes. Moreover, it is not only difficult to construct variations of oligosaccharide structures at will but also complex to purify the products or separate isomers and determine their structures because oligosaccharide elongation depends on the biosynthetic pathways of each cell. Thus, it would be desirable to stably supply oligosaccharide libraries applicable to biotechnology or medical field.

On the other hand, our research group already identified many kinds of glycosyltransferases and sulfotransferases that were difficult to obtain despite their indispensability for oligosaccharide elongation or oligosaccharide modification and explained their gene structures. Specifically, our research group identified ppGalNAc-T10 (see Non-patent document 11), T12 (see Non-patent document 12), T13 (see Non-patent document 13), T14 (see Non-patent document 14), T15 (see Non-patent document 15), and T16, T17, and T18 (see Patent document 1) as transferases of N-acetylgalactosamine (GalNAc) having the activity of transferring N-acetylgalactosamine to the hydroxyl group of serine or threonine residues of core proteins or peptide sequences via al linkage. It should be noted that ppGalNAc-T16, T17, and T18 mentioned above correspond to GalNAc-T11, T16, and T15 in Patent document 1, respectively. Our research group also identified N-acetylgalactosaminyltransferases transferring N-acetylgalactosamine to acceptor substrates other than those described above, e.g., glucuronic acid or N-acetylglucosamine (see Non-patent documents 16-22).

Our research group also identified β3GalT5 as a galactosyltransferase having the activity of transferring galactose to N-acetylglucosamine (see Non-patent document 23). We also identified β3GnT2, T3, and T4 (see Non-patent document 24), and β3GnT5 (see Non-patent document 25) as N-acetylglucosaminyltransferases having the activity of transferring N-acetylglucosamine to galactose. We also identified heparan sulfate 3-O-sulfotransferase (see Non-patent document 26) as a sulfotransferase.

Thus, oligosaccharide libraries having specific structures can be constructed by taking advantage of benefits from ensuring a stable supply of many kinds of glycosyltransferases and sulfotransferases as described above and defining the substrate specificity of each transferase.

Moreover, such transferases can be applied to not only oligosaccharide elongation or oligosaccharide modification but also glycosylation of various compounds such as proteins, peptides and lipids as well as construction of compound libraries having sulfated, phosphorylated or acylated structures. Construction of compound libraries of the present invention can also be expected to give a clue to the explanation of modification mechanisms after gene expression in vivo by analyzing the substrate specificity of transferases or the like in vitro.

### SUMMARY OF THE INVENTION

An object of the present invention is to provide novel processes for rapidly and easily preparing compound libraries of known structures. Another object of the present invention is to provide compound libraries prepared by said processes and uses thereof.

Our research group accomplished the present invention on the basis of the finding that compound libraries having multiple components of known structures can be rapidly and easily prepared by using transfer reactions based on substrate specificity and further performing the same or different transfer reaction before the previous transfer reaction has been completely terminated. Moreover, it was found that the composition ratios or other analyses of components contained in the compound libraries can be conveniently determined.

Accordingly, the present invention provides a process for preparing a compound library in the same vessel, comprising: (1) mixing one or more donor substrates, acceptor substrates, and transferases; (2) performing a transfer reaction to reach a degree of transfer of 1%-99% by incubating the mixture; and (3) stopping the transfer reaction.

Technical features of the process of the present invention are explained by way of an embodiment of a process for preparing an oligosaccharide library using a glycosyltransferase as a transferase, a glycosyl donor substrate as a donor substrate, and a glycosyl acceptor substrate as an acceptor substrate. For example, when a glycosyl acceptor substrate β4Gal-core 2 is used as a starting material and various glycosyl donor substrates and glycosyltransferases are added to sequentially perform transfer reactions as shown in scheme 1, an oligosaccharide library having eight different oligosaccharide structures can be constructed from a total of four glycosyl transfer reactions by allowing a part of the glycosyl acceptor substrate to remain unreacted in each reaction step.

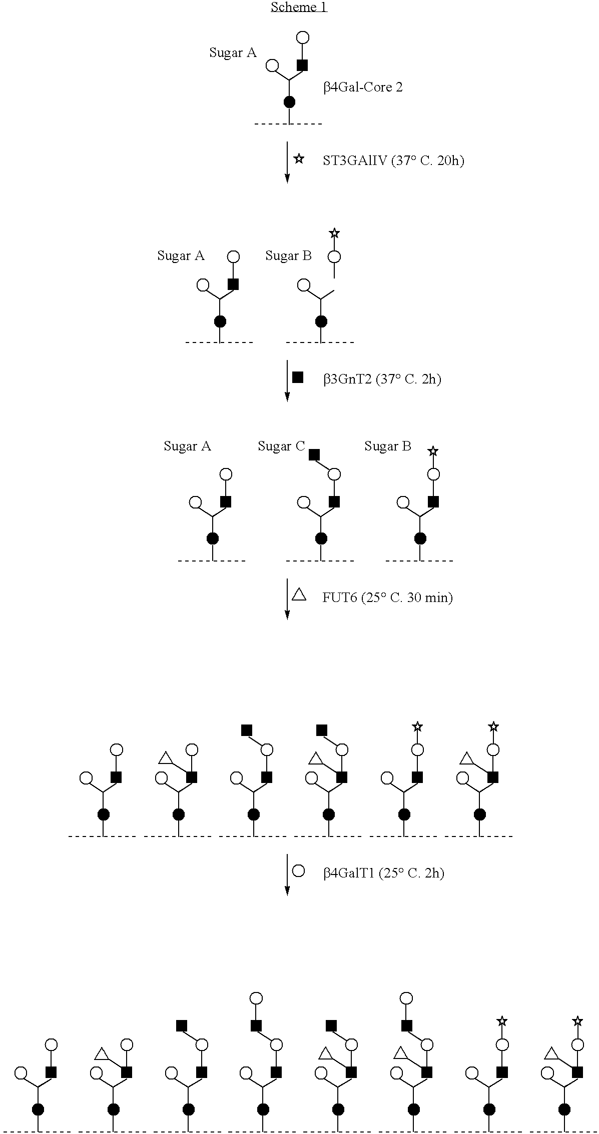

Scheme 1 is explained more specifically. When the starting material β4Gal-core 2 is designated sugar A and glycosylated oligosaccharides after reactions are designated sugar B, sugar C, etc., the reaction of the first stage in scheme 1 involves mixing UDP-N-acetylneuraminic acid (open star) (donor substrate), sugar A (acceptor substrate), and an N-acetylneuraminyltransferase (ST3Gal IV) (transferase) and performing a transfer reaction at a predetermined temperature for a predetermined period. In this case, the starting material sugar A and sugar B with N-acetylneuraminic acid attached are produced by keeping the degree of glycosylation (reaction) below 100%. Then, the reaction of the second stage involves mixing sugar A and sugar B (reaction products) with UDP-N-acetylglucosamine (solid square) (donor substrate) and an N-acetylglucosaminyltransferase (β3GnT2) (transferase) and reacting the mixture at a predetermined temperature for a predetermined period to give a compound library having three different oligosaccharide structures consisting of sugar A, sugar C, and sugar B based on substrate specificity by keeping the degree of glycosylation below 100% in the same manner as in the reaction of the first stage. Eight oligosaccharide structures can be obtained from one starting material (sugar A) by repeating similar reactions up to the fourth stage. For comparison, conventional enzymatic synthesis affords only the oligosaccharide composed of the starting material (sugar A) with N-acetylneuraminic acid (open star) and fucose (open triangle) attached as shown at the right end on the bottom line in scheme 1 even if reactions were similarly carried out until the fourth stage in the example shown in scheme 1 because conventional methods are essentially intended to reach the degree of glycosylation of 100%. Thus, an oligosaccharide library having multiple oligosaccharide structures can be rapidly and easily obtained when an oligosaccharide compound is used as a starting material along with a glycosyltransferase and a glycosyl donor substrate, for example. Moreover, it will be understood that compound libraries containing multiple structures can be prepared by using other starting materials, transferases and donor substrates without being limited to oligosaccharides, glycosyltransferases and glycosyl donor substrates so that the present invention provides a beneficial method for supplying such compound libraries.

In one embodiment of the present invention, the process may further comprise the step of repeating steps (1)-(3) using the same or different donor substrate and transferase as or from the donor substrate and transferase used in step (1). In this case, the product obtained after stopping the transfer reaction in step (3) serves as the acceptor substrate in step (1) of the subsequent cycle. Any number of cycles of steps (1)-(3) can be repeated until a compound library containing a desired structure, and the number of cycles can be determined by those skilled in the art depending on the purpose. The number of cycles is preferably one or more, more preferably 1-50, still more preferably 1-10, further more preferably 1-8, most preferably 1-6.

In one embodiment of the present invention, the degree of transfer reaction by the transferase may not reach 100% in the process for preparing a compound library of the present invention. That is, it is rather preferred that a part of the acceptor substrate remains unreacted by stopping the reaction before the transfer reaction proceeds to 100% in order to prepare a compound library containing components having different structures. The transfer reaction is preferably stopped when the degree of transfer reaches about 1%-about 99%, more preferably about 5%-about 95%, still more preferably about 10%-about 90%, further more preferably about 20%-about 80%, still further more preferably about 30%-about 70%, even more preferably about 40%-about 60%, most preferably about 50%. It will be readily appreciated that the compound library contains the most uniform amounts of components when the transfer reaction is stopped at the degree of reaction of 50% in step (3).

In one embodiment of the present invention, a mixture at a mid stage for constructing a library can be used as a starting material for constructing another library in the process for preparing a compound library of the present invention.

In one embodiment of the present invention, the order of transferases used in the process for preparing a compound library of the present invention is not limited, but those skilled in the art can select the types of transferases and the order of adding them in consideration of the substrate specificity of the transferases to prepare a compound library having a specific structure. On the other hand, compound libraries not containing a specific structure can also be prepared based on the substrate specificity of transferases.

In one embodiment of the present invention, transferases used in the process for preparing a compound library of the present invention include, but not limited to, N-acetylneuraminyltransferases, fucosyltransferases, N-acetylglucosaminyltransferases, N-acetylgalactosaminyltransferases, galactoseyltransferases, glucosyltransferases, glucuronyltransferases, mannosyltransferases, xylosyltransferases, sulfotransferases, phosphotransferases, and acyltransferases.

In one embodiment of the present invention, the acceptor substrate used in the process for preparing a compound library of the present invention is not specifically limited so far as transferases can transfer a substituent such as a glycosyl residue, sulfate group, phosphate group or acyl group to it from a donor substrate on the basis of the substrate specificity. Preferably, it is a glycosyl acceptor substrate, protein, peptide, amino acid or lipid or a modified form thereof, more preferably a glycosyl acceptor substrate or peptide, still more preferably a glycosyl acceptor substrate. The glycosyl acceptor substrate is preferably a glycopeptide, glycoprotein, monosaccharide, oligosaccharide, glycolipid, protein or peptide or a modified form thereof, more preferably a glycopeptide, glycoprotein or oligosaccharide or a modified form thereof, still more preferably a glycopeptide or oligosaccharide or a modified form thereof.

In one embodiment of the present invention, donor substrates used in the process for preparing a compound library of the present invention include, but not limited to, sugar nucleotides, dolichol phosphate-sugars, 3′-phosphoadenosine 5′-phosphosulfate (PAPS), adenosine triphosphate (ATP), and acetyl-CoA.

According to the present invention, a compound library prepared by the process for preparing a compound library of the present invention is provided.

In one embodiment of the present invention, a compound library is provided wherein the structure of each component of the compound library is identified from its molecular weight. Methods for determining the structure of each component from its molecular weight include mass spectrometry, electrophoresis, and gel filtration.

According to the present invention, a chip using the compound library of the present invention is provided. Compounds used in the chip are obtained by the process for preparing a compound library of the present invention. In one embodiment of the present invention, each component contained in the compound library can be used after isolation/purification. In one embodiment of the present invention, each component contained in the compound library can also be used without isolation/purification.

### BRIEF DESCRIPTION OF THE DRAWINGS

FIG. 1 shows the results of measurements by using Reflex IV (mass spectrometer) for the oligosaccharide structures obtained by four transfer reactions from a glycopeptide having β4Gal-core 2 structure as a starting material (glycosyl acceptor substrate) with various glycosyltransferases and sugars (glycosyl donor substrates). Six oligosaccharides were obtained by the end of reaction 4. In the figure, solid circles represent N-acetylgalactosamine, open circles represent galactose, solid squares represent N-acetylglucosamine, open triangles represent fucose, and open stars represent N-acetylneuraminic acid.

FIG. 2 shows the results of measurements by using Reflex IV (mass spectrometer) for the oligosaccharide structures obtained by four transfer reactions from a glycopeptide having β4Gal-core 2 structure as a starting material (glycosyl acceptor substrate) with various glycosyltransferases and sugars (glycosyl donor substrates). The order of reaction 2 and reaction 3 in FIG. 1 was changed. Eight oligosaccharides were obtained by the end of reaction 4′. In the figure, solid circles represent N-acetylgalactosamine, open circles represent galactose, solid squares represent N-acetylglucosamine, open triangles represent fucose, and open stars represent N-acetylneuraminic acid.

FIG. 3 shows the results of measurements by using Reflex IV (mass spectrometer) for the lactosamine structure (Galβ1-4GlcNAcβ1-3) obtained in one reaction from Tn-Muc1a as a starting material with two glycosyl donor substrates (UDP-GlcNAc and UDP-Gal) and three glycosyltransferases (two N-acetylglucosaminyltransferases and a galactosyltransferase). In the figure, solid circles represent N-acetylgalactosamine, solid squares represent N-acetylglucosamine, and open circles represent galactose.

FIG. 4 shows the results of measurements by using Reflex IV (mass spectrometer) for the oligosaccharide structures obtained by using core 3-Muc1a structure as a starting material with an N-acetylglucosaminyltransferase (β3GnT2), a galactosyltransferase (β4GalT1), a glycosyl acceptor substrate (core 3-Muc1a), and glycosyl donor substrates (UDP-GlcNAc and UDP-Gal) to prepare oligosaccharides having a polylactosamine structure (reaction A), which were further reacted with a sialyltransferase (ST3GalIII) and a glycosyl donor substrate (CMP-Neu5Ac) to prepare polylactosamine chains sialylated at the non-reducing end. In the figure, solid circles represent N-acetylgalactosamine, solid squares represent N-acetylglucosamine, open circles represent galactose, and open stars represent N-acetylneuraminic acid.

### DETAILED DESCRIPTION OF THE INVENTION

For explaining the present invention, preferred embodiments are described in detail below.

1. Transferases

(1) Glycosyltransferases

Glycosyltransferases are proteins that catalyze the transfer of a glycosyl residue from a glycosyl donor substrate (e.g., sugar nucleotides) to a glycosyl acceptor substrate (e.g., glycopeptides, peptides). The catalytic reaction is expressed by the reaction formula:
glycosyl acceptor substrate+sugar 1-nucleotide [symbol] sugar 1-glycosyl acceptor substrate+nucleotide formula (A).

In formula (A), the product with sugar 1 attached “sugar 1-glycosyl acceptor substrate” serves as the glycosyl acceptor substrate in the subsequent reaction. For example, if the glycosyl acceptor substrate is reacted with sugar 2-nucleotide in the presence of a glycosyltransferase transferring sugar 2, the product is sugar 2-sugar 1-glycosyl acceptor substrate when the reaction proceeds to 100%.

As described above, our research group already succeeded in cloning genes encoding N-acetylgalactosaminyltransferases, galactosyltransferases, N-acetylglucosaminyltransferases, fucosyltransferases, glucuronyltransferases and sulfotransferases having various substrate specificities.

(a) N-acetylgalactosaminyltransferases

N-acetylgalactosaminyltransferases are proteins that catalyze the transfer of an N-acetylgalactosamine residue to a glycosyl acceptor substrate. Eighteen human N-acetylgalactosaminyltransferases transferring N-acetylgalactosamine to the hydroxyl group of a non-glycosylated acceptor substrate serine/threonine have been known so far. Our research group already isolated genes encoding pp-GalNAc-T10, T12, T14, T15, T16, T17, and T18, and determined their nucleotide sequences and putative amino acid sequences (see Patent document 1). The nucleotide sequences, putative amino acid sequences, substrate specificities, and expression distributions in tissues of the nucleic acids encoding these N-acetylgalactosaminyltransferases are disclosed in Patent document 1. It should be noted that pp-GalNAc-T10 corresponds to GalNAc-T13 disclosed in Patent document 1, pp-GalNAc-T12 corresponds to GalNAc-T14, pp-GalNAc-T14 corresponds to GalNAc-T12, pp-GalNAc-T15 corresponds to GalNAc-T17, pp-GalNAc-T16 corresponds to GalNAc-T11, pp-GalNAc-T17 corresponds to GalNAc-T16, and pp-GalNAc-T18 corresponds to GalNAc-T15, respectively (see Table 1). All of the other N-acetylgalactosaminyltransferases are disclosed in prior technical documents described in Table 1.

Our research group also identified glycosyltransferases belonging to N-acetylgalactosaminyltransferases but transferring N-acetylgalactosamine to glycosyl acceptor substrates other than those described above, e.g., glucuronic acid or N-acetylglucosamine (see Non-patent documents 16-22).

Although the N-acetylgalactosaminyltransferases described above are specific for glycosyl acceptor substrates having serine/threonine, glucuronic acid, or N-acetylglucosamine, N-acetylgalactosaminyltransferases used in processes for preparing an oligosaccharide library of the present invention are not specifically limited so far as they transfer N-acetylgalactosamine.

TABLE 1
N-acetylgalactosaminyltransferase and substrate specificity thereof

| | | | | Name in |
|---|---|---|---|---|
| | | | | International |
| | | Substrate | | Publication |
| Name | Origin | specificity | References | W003/057887 |
| pp-GalNAc-T1 | Human | Ser/Thr | White, T. et al. (1995) | |
| pp-GalNAc-T2 | Human | Ser/Thr | White, T. et al. (1995) | |
| pp-GalNAc-T3 | Human | Ser/Thr | Bennet, E. P. et al. (1996) | |
| pp-GalNAc-T4 | Human | Ser/Thr | Bennet, E. P. et al. (1998) | |
| pp-GalNAc-T5 | Rat | Ser/Thr | Ten Hagen, K. G. et al. (1998) | |
| pp-GalNAc-T6 | Human | Ser/Thr | Bennet, E. P. et al. (1999) (1) | |
| pp-GalNAc-T7 | Human | Ser/Thr | Bennet, E. P. et al. (1999) (2) | |
| pp-GalNAc-T8 | Human | Ser/Thr | White, K. E. et al. (2000) | |
| pp-GalNAc-T9 | Human | Ser/Thr | Toba, S. et al. (2000) | |
| pp-GalNAc-T10 | Rat | Ser/Thr | Ten Hagen, K. G. et al. (2001) | |
| pp-GalNAc-T10 | Human | Ser/Thr | Cheng, L. et al. (2002) | GalNAc-T13 |
| pp-GalNAc-T11 | Human | Ser/Thr | Schwientek, Y. et al. (2002) | |
| pp-GalNAc-T12 | Human | Ser/Thr | Guo, J. M. et al. (2002) | GalNAc-T14 |
| pp-GalNAc-T13 | Human | Ser/Thr | Zhang, Y. et al. (2003) | |
| pp-GalNAc-T14 | Human | Ser/Thr | Wang, H. et al. (2003) | GalNAc-T12 |
| pp-GalNAc-T15 | Human | Ser/Thr | Cheng, L. et al. (2004) | GalNAc-T17 |
| pp-GalNAc-T16 | Human | Ser/Thr | International Publication | GalNAc-T11 |
| | | | Number: W003/057887 | |
| pp-GalNAc-T17 | Human | Ser/Thr | International Publication | GalNAc-T16 |
| | | | Number: W003/057887 | |
| pp-GalNAc-T18 | Human | Ser/Thr | International Publication | GalNAc-T15 |
| | | | Number: W003/057887 | |

(b) Galactosyltransferases

Our research group already identified β3GalT5 as a galactosyltransferase that catalyzes the transfer of galactose to N-acetylglucosamine (see Non-patent document 23). Although these galactosyltransferases are specific for glycosyl acceptor substrates having N-acetylglucosamine, galactosyltransferases used in processes for preparing an oligosaccharide library of the present invention are not specifically limited so far as they transfer galactose.

(c) N-acetylglucosaminyltransferases

Our research group already identified β3GnT2, T3, T4 (see Non-patent document 24), and P3GnT5 (see Non-patent document 25) as N-acetylglucosaminyltransferases that catalyze the transfer of N-acetylglucosamine to galactose. Although these N-acetylglucosaminyltransferases are specific for acceptor substrates having N-acetylglucosamine, N-acetylglucosaminyltransferases used in processes for preparing a compound library of the present invention are not specifically limited so far as they transfer N-acetylglucosamine.

(d) Other Glycosyltransferases

Glycosyltransferases used in processes for preparing a compound library of the present invention other than those described above include, but not limited to, N-acetylneuraminyltransferases, fucosyltransferases, glucuronyltransferases, glucosyltransferases, mannosyltransferases, and xylosyltransferases. Some of these glycosyltransferases are commercially or otherwise available.

Generally, it is well known that proteins having a physiological activity such as glycosyltransferases may retain the physiological activity even when one or more amino acids in their amino acid sequences are substituted or deleted or one or more amino acids are inserted or added into the amino acid sequences. It is also known that naturally occurring proteins include variant proteins having one or more amino acid changes resulting from the genetic variation between varieties of species producing them or between ecotypes or the presence of very similar isozymes. Therefore, glycosyltransferases having an amino acid sequence obtained by substituting or deleting one or more amino acids in an amino acid sequence already known or by inserting or adding one or more amino acids into such an amino acid sequence are also included in the scope of the present invention so far as they have the transferase activity described above.

(2) Other Transferases

Transferases used in processes for preparing a compound library of the present invention other than the glycosyltransferases described above include any transferases capable of transferring a substituent from a donor substrate to an acceptor substrate without limitation. Such transferases include sulfotransferases, phosphotransferases, and acyltransferases.

(a) Sulfotransferases

Sulfotransferases catalyze the reaction transferring sulfate from a sulfate donor substrate active sulfate (3′-phosphoadenosine 5′-phosphosulfate: PAPS) to the hydroxyl group, amino group, or thiol group of an acceptor substrate. In post-translational modification of proteins, sulfate is introduced into the hydroxyl group on the side chain of an amino acid residue tyrosine to control the activity of the proteins. Sulfation in oligosaccharides varies especially in glycosaminoglycans. Sulfated glycosaminoglycans have a repeating disaccharide structure and include chondroitin sulfate, heparan sulfate, dermatan sulfate, and keratan sulfate. For example, chondroitin sulfate is basically composed of a glucuronic acid residue and an N-acetylgalactosamine residue sulfated at different sites depending on the type of sulfotransferase.

Sulfotransferases used in processes for preparing a compound library of the present invention are not specifically limited so far as they transfer sulfate. Preferred are tyrosine sulfotransferases, chondroitin sulfotransferases, heparan sulfate N-sulfotransferases, heparan sulfate O-sulfotransferases, keratan sulfotransferases, dermatan/chondroitin sulfate 2-sulfotransferases, β-galactose 3-O-sulfotransferases, NHK-1 sulfotransferases, galactose/N-acetylgalactosamine/N-acetylglucosamine 6-O-sulfotransferases (GSTs), and N-acetylgalactosamine 4-O-sulfotransferases, more preferably β-galactose 3-O-sulfotransferases, NHK-1 sulfotransferases, N-acetylglucosamine 6-O-sulfotransferases, and N-acetylgalactosamine 4-O-sulfotransferases. Sulfotransferases are described in, e.g., Handbook of Glycosyltransferase and Related Genes.

(b) Phosphotransferases

Phosphotransferases (kinases) catalyze the reaction transferring phosphate from a phosphate donor (e.g., adenosine 5′-triphosphate) to the hydroxyl group of an acceptor substrate. In post-translational modification of proteins, phosphate is introduced into the hydroxyl group on the side chain of an amino acid residue tyrosine, serine or threonine to control the activity of the proteins. Phosphorylation in oligosaccharides is predominant in various metabolism pathways. For example, hexokinases are involved in the pathway synthesizing glucose 6-phosphate from glucose.

Phosphotransferases used in processes for preparing a compound library of the present invention are not specifically limited so far as they transfer phosphate. Preferred are tyrosine kinases, serine-threonine kinases, hexokinases, and N-acetylglucosamine kinases, more preferably hexokinases, and N-acetylglucosamine kinases. Phosphotransferases are described in, e.g., Non-patent documents 27-29.

(c) Acyltransferases

Acyltransferases catalyze the reaction transferring an acyl group from an acyl donor substrate acetyl-CoA to the carboxyl group, hydroxyl group, amino group, or thiol group of an acceptor substrate. Especially, acyltransferases are involved in the metabolism of steroids and fatty acids. In post-translational modification of proteins, an acyl group is introduced into the carboxyl group on the side chain of an amino acid residue aspartic acid or glutamic acid to control the activity of the proteins. Acylation in oligosaccharides is known to play a pivotal role for controlling various biological processes. For example, sialate-4-O-acetyltransferases are involved in the reaction transferring acetyl to the hydroxyl group at the 4-position of a sialic acid attached to the non-reducing end side.

Acyltransferases used in processes for preparing a compound library of the present invention are not specifically limited so far as they transfer an acyl group. Preferred are sterol O-acyltransferases, sialate-4-O-acetyltransferases, sialate-7-(9)-O-acetyltransferases, and galactose O-acetyltransferases, more preferably sialate-4-O-acetyltransferases, sialate-7-(9)-O-acetyltransferases, and galactose O-acetyltransferases. Acyltransferases are described in, e.g., Non-patent documents 30 and 31.

Any transferases that can be used in processes for preparing a compound library of the present invention are not limited in their origins or preparation processes so far as they have characteristics described above. That is, transferases may be any of naturally occurring proteins, proteins expressed from recombinant DNAs by genetic engineering techniques, or chemically synthesized proteins. The species from which transferases are derived are not limited, but preferably animals, microorganisms, and plants, more preferably mammals, E. coli, yeasts, and archaebacteria, still more preferably humans, rats, mice, xenopus, hamsters, and monkeys, further more preferably humans, rats, and mice.

Transferase used in processes for preparing a compound library of the present invention also include variants of transferases altered by genetic engineering techniques to increase or decrease substrate specificity. Construction of such variants can be performed by those skilled in the art using well known methods.

2. Acceptor Substrates and Donor Substrates

(1) Acceptor Substrates

Transfer reactions to acceptor substrates such as glycosylation, sulfation, phosphorylation, and acylation are performed by transferring various substituents to acceptor substrates in the presence a transferase as a catalyst suitable for the type of substituent. For example, it is known that N-acetylgalactosamine residues are substrate-specifically transferred to at least the hydroxyl group of serine/threonine, glucuronic acid, and N-acetylglucosamine as acceptor substrates in proteins or peptides when the transferase is an N-acetylgalactosaminyltransferase.

As used herein the term “acceptor substrate” means a compound to which a substituent is transferred by various transferases on the basis of their substrate specificity. The acceptor substrate is not limited so far as it is a compound having a functional group (e.g., hydroxyl group, carboxyl group, amino group) to which a substituent is transferred by a transferase. The acceptor substrate is preferably a glycosyl acceptor substrate, protein, peptide or lipid, more preferably a glycosyl acceptor substrate or peptide, still more preferably a glycosyl acceptor substrate. The term “glycosyl acceptor substrate” means a substrate to which a sugar is transferred. Preferably, it is a glycopeptide, glycoprotein, monosaccharide, oligosaccharide, glycolipid, protein or peptide or a modified form thereof, more preferably a glycopeptide, glycoprotein or oligosaccharide or a modified form thereof, still more preferably a glycopeptide or oligosaccharide or a modified form thereof. The glycosyl residue constituting the glycosyl acceptor substrate is not limited to naturally derived sugars, oligosaccharides or the like, but may also be a modified form thereof. The modified form means a derivative in which one or more hydroxyl groups in the glycosyl residue are replaced by a sulfate group, phosphate group, purine base, pyrimidine base, alkyl group, acyl group, amide group, or amino group.

The moieties other than the sugar moiety of the glycosyl acceptor substrate include, but not limited to, proteins, peptides, lipids, alkyl groups, acyl groups, amino groups, hydrazides and oximes that can be attached to any hydroxyl group of the sugar moiety (preferably the hydroxyl group at the reducing end). Thus, the glycosyl acceptor substrate used in processes for preparing a compound library of the present invention is preferably a protein (or peptide), glycoprotein (or glycopeptide) (e.g., O-glycans, N-glycans), glycolipid, oligosaccharide, monosaccharide (e.g., N-acetylglucosamine, glucuronic acid, N-acetylgalactosamine, galactose, glucose, mannose, fucose) or amino acid (e.g., serine, threonine, asparagine) or a modified form thereof, more preferably a glycopeptide, glycolipid, oligosaccharide or monosaccharide or a modified form thereof, still more preferably a glycopeptide or glycolipids or a modified form thereof, most preferably a glycopeptide. The “O-glycan” is a common name of a glycoprotein or glycopeptide consisting of an oligosaccharide linked to the serine/threonine residue of a protein or peptide and is classified by oligosaccharide structure into Tn antigen, core 1, core 2, core 3, core 4, core 5, core 6, core 7, and core 8. Here, Tn antigen is GalNAcα1-, core 1 is Galβ1-3GalNAcα1-, core 2 is GlcNAcβ1-6(Galβ1-3)GalNAcα1-, core 3 is GlcNAcβ1-3GalNAcα1-, core 4 is GlcNAcβ1-6(GlcNAcβ1-3)GalNAcα1-, core 5 is GalNAcα1-3GalNAcα1-, core 6 is GlcNAcβ1-6GalNAcα1-, core 7 is GalNAcα1-6GalNAcα1-, and core 8 is Galα1-3GalNAcα1-.

(2) Donor Substrates

Transfer reaction means the transfer of a substituent constituting a donor substrate to an acceptor substrate in the presence of a transferase as a catalyst. For example, when a sialic acid residue (e.g., Neu5Ac) is to be transferred to an acceptor substrate having β4Gal-core 2 structure, CMP-Neu5Ac can be used as a donor substrate.

As used herein, the term “donor substrate” means a compound constituting a substituent to be transferred by a transferase on the basis of its substrate specificity when the transferase recognizes an acceptor substrate. The donor substrate is not specifically limited so far as it does not affect substrate specificity of transferases and provides a source for transferring a substituent to an acceptor substrate. Preferably, it is a sugar nucleotide, dolichol phosphate-sugar, 3′-phosphoadenosine 5′-phosphosulfate (PAPS), adenosine triphosphate (ATP) or acetyl-CoA, more preferably a sugar nucleotide, dolichol phosphate-sugar or 3′-phosphoadenosine 5′-phosphosulfate (PAPS), most preferably a sugar nucleotide.

3. Processes for Preparing a Compound Library

Processes for preparing a compound library of the present invention involve a reaction transferring a substituent of a donor substrate to an acceptor substrate in the same vessel, and are characterized in that a diverse compound library is constructed by sequentially adding transferases to a mixture of a compound with a substituent attached and an unreacted compound with no substituent attached after stopping the reaction or not before the degree of transfer by each transferase reaches 100%. In processes of the present invention, transfer reactions can be continuously performed without recovering and purifying the product in each reaction step and compound libraries having multiple substituents can be constructed, in contrast to conventional enzymatic synthesis.

According to the present invention, a process for preparing a compound library in the same vessel is provided, comprising: (1) mixing one or more donor substrates, acceptor substrates, and transferases; (2) performing a transfer reaction to reach a degree of transfer of 1%-99% by incubating the mixture; and (3) stopping the transfer reaction.

The vessel used in the process of the present invention can be appropriately selected by those skilled in the art in the steps of preparing a compound library. Preferably, it is a microtube, plate, or flask, more preferably a microtube or plate, most preferably a microtube.

The donor substrate, acceptor substrate, and transferase used in the process of the present invention are as described in detail above. The donor substrate and acceptor substrate used in step (1) are not limited in the types to be mixed so far as the transferase is substrate-specific for them. The transferase used in the same step is not limited in the type to be added so far as it is substrate-specific for the donor substrate and the acceptor substrate. For the incubation in step (2), any apparatus can be used so far as it can maintain a reaction period and a reaction temperature suitable for the transferase to produce the activity of transferring a substituent. The apparatus is preferably a temperature-controlled shaker, PCR system, incubator, temperature-controlled bath or heat block, more preferably a temperature-controlled shaker or PCR system. The reaction period of the transferase means a period required to reach a predetermined degree of reaction to which a substituent is transferred from a donor substrate to an acceptor substrate after the transferase is added, as described below, and varies with the predetermined degree of reaction and reaction conditions of each transferase.

In one embodiment of the present invention, steps (1)-(3) may be repeated once or more using the same or different donor substrate and transferase as or from the donor substrate and transferase used in step (1). A compound library containing specific proportions of a plurality of compounds having desired structures can be obtained by appropriately selecting a donor substrate and a transferase.

Means for stopping the transfer reaction in step (3) is not specifically limited so far as the transferase can be deactivated or removed when a predetermined degree of transfer is reached. Preferably, it is heat treatment, addition of a protein modifier, addition of an inhibitor, filtration or solid phase extraction, more preferably heat treatment or filtration. Here, the degree of transfer at which the transfer reaction is stopped in step (3) can be appropriately determined by those skilled in the art to prepare a compound library containing a predetermined amount of a specific structure. For example, a mixing ratio of 1:1 between a compound having one substituent and a compound not having it is achieved by stopping the reaction when the degree of reaction by the transferase reaches 50% during the process for preparing a compound library. On the other hand, the proportion of the presence of a specific substituent can be modulated by changing the degree of transfer in the range of 1-99% rather than 50%. The degree of transfer by the transferase in the process for preparing a compound library of the present invention is preferably about 1-99%, more preferably about 5-95%, still more preferably about 10-90%, further more preferably about 20-80%, still further more preferably about 30-70%, even more preferably about 40-60%, most preferably about 50%. For example, when the degree of transfer by each transferase in the first and second stages is 50% in scheme 2, the ratio of compound A, compound C, compound B and compound D produced by the two stages of reaction is 1:1:1:1. When the degree of transfer in each reaction stage is 40%, a compound library containing compound A: compound C: compound B compound D=9:6:6:4 can be obtained. Thus, compound libraries containing different ratios of components having specific structures produced can be constructed by changing the degrees of transfer by various transferases used.

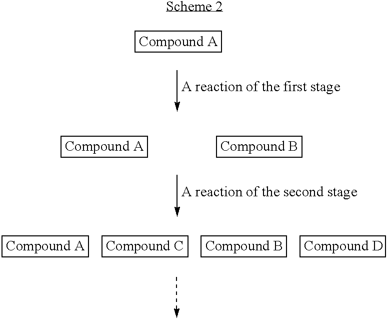

In one embodiment of the present invention wherein steps (1)-(3) are repeated, a step in which the degree of transfer is 100% may be included in a partial transfer reaction. By partially including such a step, a compound library having an increased proportion of only a component having a specific structure can be prepared.

In one embodiment of the present invention, the step of collecting a part of an unreacted acceptor substrate before starting a transfer reaction and adding the collected acceptor substrate to the product after stopping the transfer reaction may be included in order to prepare a more diverse compound library. By including this reaction step, a diverse compound library can be prepared.

In one embodiment of the present invention, a mixture at a mid stage for constructing a library can be used as a starting material for constructing another library in the process for preparing a compound library of the present invention.

The degree of transfer in each transfer reaction can be determined by measuring, but not limited to, the concentration, composition ratios or weight ratios of unreacted materials and the reaction product in solution. A preferred method is mass spectrometry, in which a part of the reaction solution is collected and can be measured for the amount (or composition ratio) of each component present in the reaction solution by a mass spectrometer. This determination of the degree of transfer by mass spectrometry is based on the fact that each mass spectrum (m/z) shown in the spectra after mass spectrometry corresponds to the structure of one compound. Unreacted materials, the product and amounts (or composition ratios) thereof, or the structure of each component contained in the reaction solution can be rapidly and readily identified by one measurement using a mass spectrometer without necessity of isolating/purifying the product in each reaction step. Thus, a compound library containing components each having a known structure can be prepared by the process for preparing a compound library of the present invention.

The “mass spectrometry” is an analytical method for mostly measuring the mass of a sample using a gas phase ion spectrometer comprising a sample introduction part, an ionization part and a mass spectrometric part (mass separation part and detection part). Specifically, a sample is ionized in an ionization part (or apparatus), and the resulting ionized molecules are separated according to the mass/charge (m/z) in a mass spectrometric part and detected in a detection part. As used herein, the term “mass spectrometer” means an apparatus capable of testing a sample, e.g., biological molecules such as oligosaccharides, sugars, proteins, peptides and nucleic acids by mass spectrometry. Methods for ionizing biological molecules include, but not limited to, Matrix-Assisted Laser Desorption Ionization (MALDI), Laser Desorption (LD), Fast Atom Bombardment (FAB), Liquid Secondary Ion Mass Spectrometry (LSIMS), Liquid Ionization (LI), Electrospray Ionization (ESI), and Atmospheric Pressure Chemical Ionization (APCI). Ions of ionized biological molecules are separated according to the mass/charge (m/z) inherent to the biological molecules by using electromagnetic interactions. The mass spectrometric part for separating and detecting ions is an analyzer including, but not limited to, time-of-flight (TOF), quadrupole ion trap time-of-flight (QIT-TOF), quadrupole, ion trap, magnetic sector, and Fourier transform ion cyclotron resonance (FT-ICR) analyzers. Examples of MALDI-TOF mass spectrometers include Ettan MALDI-TOF Pro (Amersham Biosciences), and Reflex IV (Brucker).

In one embodiment of the present invention, the number of cycles of steps (1)-(3) can be appropriately determined by those skilled in the art to obtain a compound library having a desired structure. In order to prepare a compound library having multiple structures, the number of cycles of steps (1)-(3) is preferably increased. The number of cycles is preferably one or more, more preferably 1-50, still more preferably 1-10, further more preferably 1-8, most preferably 1-6. For example, an oligosaccharide library containing a maximum of eight oligosaccharides was successfully constructed via four stages of glycosylation reactions from one glycosyl acceptor substrate (β4Gal-core 2-Muc1a) by repeating 4 cycles of steps (1)-(3) in Example 1 below. In Example 2, an oligosaccharide library consisting of eight polylactosamines having different repetition numbers of lactosamines was successfully constructed by only one cycle of steps (1)-(3) from one glycosyl acceptor substrate (Tn-Muc1a).

In one embodiment of the present invention, the order of transferases used in the process for preparing a compound library of the present invention is not limited, but those skilled in the art can prepare a compound library containing a specific structure based on the substrate specificity of transferases by selecting the types of transferases and the order of adding them to contain a compound having a specific structure. For example, two oligosaccharides that were not obtained when an N-acetylneuraminyltransferase, a fucosyltransferase, an N-acetylglucosaminyltransferase, and a galactosyltransferase were added in this order to the reaction system were obtained by changing the order of adding the fucosyltransferase (second) and the N-acetylglucosaminyltransferase (third), as described in Example 1 below. On the other hand, a compound library not containing a specific structure can also be constructed by changing the combination of transferases.

4. Compound Libraries

According to the present invention, compound libraries prepared by the processes described above are provided. In the processes for preparing a compound library of the present invention, compound libraries containing multiple known structures can be rapidly and easily prepared, unlike conventional methods.

Compound libraries of the present invention contain certain proportions of components having multiple structures depending on the types of the acceptor substrate, donor substrate and transferase used, the degree of transfer, and the number of cycles of steps (1)-(3) as described above. The amount of a specific compound among components contained in the compound libraries can be modulated by changing the degree of reaction in the range of 1-99% and/or changing the order of adding the transferases used.

In one embodiment of the present invention, a compound library is provided characterized in that the structure of each component of the compound library is identified from its molecular weight.

More specifically, an oligosaccharide library containing a total of six oligosaccharides, i.e.,

(i) Galβ1-4GlcNAcβ1-6(Galβ1-3)GalNAcα1-Muc1a,

(ii) Galβ1-4(Fucα1-3)GlcNAcβ1-6(Galβ1-3)GalNAcα1-Muc1a,

(iii) GlcNAcβ1-3Galβ1-4GlcNAcβ1-6(Galβ1-3)GalNAcα1-Muc1a,

(iv) Galβ1-4GlcNAcβ1-3Galβ1-4GlcNAcβ1-6(Galβ1-3)GalNAcα1-Muc1a,

(v) Neu5Acα2-3Galβ1-4GlcNAcβ1-6(Galβ1-3)GalNAcα1-Muc1a, and

(vi) Neu5Acα2-3Galβ1-4(Fucα1-3)GlcNAcβ1-6(Galβ1-3)GalNAcα1-Muc1a

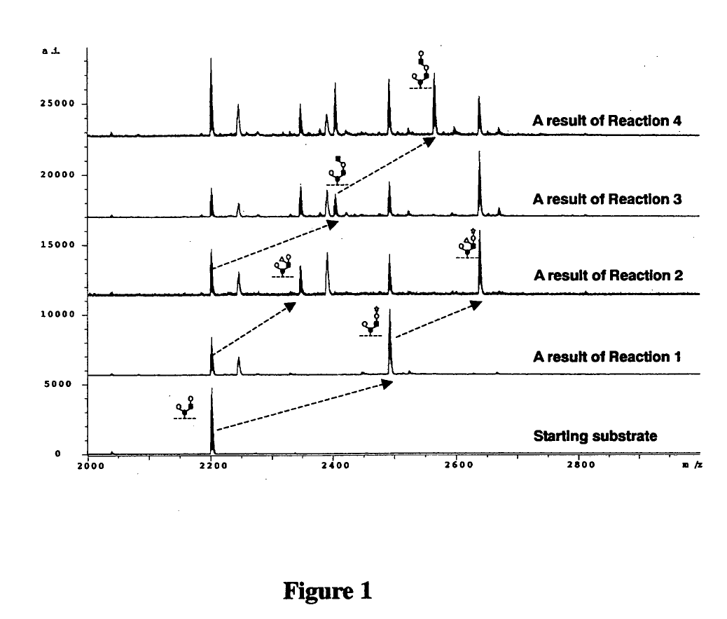

was successfully constructed by using β4Gal-core 2-Muc1a (Ala-His-Gly-Val-Thr-Ser-Ala-Pro-Asp-Thr-Arg (SEQ ID NO: 1)) as a glycosyl acceptor substrate (starting material) along with an N-acetylneuraminyltransferase (ST3Gal IV), a fucosyltransferase (FUT6), an N-acetylglucosaminyltransferase (β3GnT2), and a galactosyltransferase (β4GalT1) in this order at a glycosylation degree of 50% by each glycosyltransferase, as described in Example 1 below (see FIG. 1). As used herein, Gal means galactose, GlcNAc means N-acetylglucosamine, GalNAc means N-acetylgalactosamine, Fuc means fucose, and Neu5Ac means N-acetylneuraminic acid. In this process, there is a possibility that two other oligosaccharides (as indicated by crosses in scheme 3 below) may be theoretically synthesized in view of the types of glycosyltransferases added, but such oligosaccharides were not obtained by the reaction sequence above. However, the oligosaccharides that were not obtained by the previous method, i.e., GlcNAcβ1-3Galβ1-4(Fucα1-3)GlcNAcβ1-6(Galβ1-3)GalNAcα1-Muc1a, and Galβ1-4GlcNAcβ1-3Galβ1-4(Fucα1-3)GlcNAcβ1-6(Galβ1-3)GalNAcα1-Muc1a were successfully obtained by changing the order of adding the fucosyltransferase (second) and the N-acetylglucosaminyltransferase (third). These oligosaccharide structures could be readily determined by a mass spectrometer.

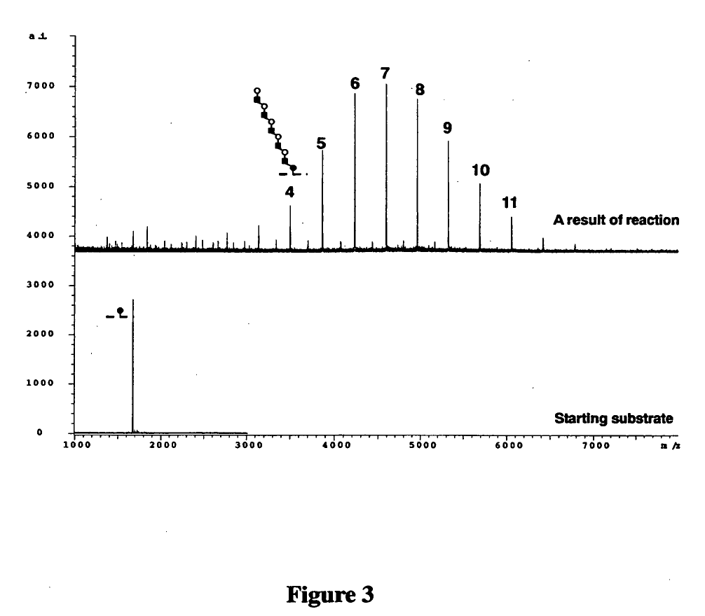

As described in Example 2 below, an oligosaccharide library containing oligosaccharides elongated by mostly 4-11 units of a lactosamine structure (Galβ1-4GlcNAcβ1-3) was successfully constructed in one reaction without repeating steps (1)-(3) when Tn-Muc1a was used as a starting material and two glycosyl donor substrates (UDP-GlcNAc and UDP-Gal) and three glycosyltransferases (two N-acetylglucosaminyltransferases and a galactosyltransferase) were added (see FIG. 3). Moreover, an oligosaccharide having an N-acetylneuraminic acid residue at the oligosaccharide elongation end was also successfully prepared by using an N-acetylneuraminyltransferase and CMP-Neu5Ac on this lactosamine structure.

On the other hand, an oligosaccharide library containing sialyl Lewis A (Neu5Acα2-3Galβ1-3(Fucα1-4)GlcNAcβ1-3GalNAcα1-), sialyl Lewis X (Neu5Acα2-3Galβ1-4(Fucα1-3)GlcNAcβ1-3GalNAcα1-), antigen A (GalNAcα1-3(Fucα1-2)Galβ1-3GlcNAcβ1-3GalNAcα1-), or antigen B (Galα1-3(Fucα1-2)Galβ1-3GlcNAcβ1-3GalNAcα1-) can be obtained by repeating 2-3 cycles of steps (1)-(3) using core 3 (GlcNAcβ1-3GalNAcα1-) structure as a starting material with various glycosyltransferases and glycosyl donor substrates, as described in Example 4 below. More specifically, when an oligosaccharide library containing sialyl Lewis A is to be prepared, core 3 structure is mixed with galactose as a glycosyl donor substrate to give Galβ1-3 core 3 structure via a galactosyltransferase-mediated transfer reaction and the product is further reacted with N-acetylneuraminic acid and fucose as glycosyl donor substrates in the presence of an N-acetylneuraminyltransferase and a fucosyltransferase, whereby an oligosaccharide library containing sialyl Lewis A and other three oligosaccharides (Galβ1-3GlcNAcβ1-3GalNAcα1-, Galβ1-3(Fucα1-4)GlcNAcβ1-3GalNAcα1-, Neu5Acα2-3Galβ1-3GlcNAcβ1-3GalNAcα1-) can be obtained.

5. Chips

According to the present invention, chips suitable for applying compound libraries of the present invention for diagnoses of diseases or other purposes are provided. As used herein, the term “chip” means a compound library of the present invention on a solid substrate, e.g., a chip, membrane, filter or glass. Specifically, by using a chip of the present invention, molecules or the like that react with a specific compound in a compound library on the chip can be rapidly detected. For example, when an oligosaccharide library is used on a chip, oligosaccharide-recognizing molecules, e.g., lectins, viruses, microbes, toxins, and bacteria recognize an oligosaccharide immobilized on the chip and bind or otherwise react with it, whereby a signal from each oligosaccharide is detected and the data obtained are analyzed. Methods for immobilizing compounds in compound libraries on solid substrates include, but not limited to, hydrophobic bonds to substrate surfaces, or amide bonds or sulfide bonds to chemically modified plate surfaces.

The following examples further illustrate the present invention with no intention to limit the technical scope of the present invention thereto. Those skilled in the art can easily add modifications/changes to the present invention on the basis of the description herein, and these modifications/changes are also included in the technical scope of the present invention.

### Example 1

### Construction of Oligosaccharide Libraries from β4Gal-Core 2-Muc1a

A solution containing a sialyltransferase (ST3Gal IV), a glycosyl acceptor substrate (β4Gal-core 2-Muc1a), a glycosyl donor substrate (CMP-Neu5Ac), a divalent cation, a buffer and others in the volumes shown in Table 2A below was incubated at 37° C. for 20 hours. The reaction process was monitored on a mixture of a 0.1 μL sample of this reaction solution and 0.5 μL of 2,5-dihydrobenzoic acid (DHB) using a mass spectrometer (Reflex IV (Brucker)). At the point when the reaction proceeded to about 50%, the reaction was stopped by heating the reaction solution at 100° C. for 5 minutes to deactivate the enzyme. This reaction solution is designated “reaction solution 1” (reaction 1). Then, a fucosyltransferase (FUT6) and a glycosyl donor substrate (GDP-Fuc) in the volumes shown in Table 2B were added to reaction solution 1, and the mixture was reacted at 25° C. for 30 minutes. This enzymatic reaction solution was monitored by Reflex IV, and after confirming that the reaction has proceeded to about 50%, the enzyme was deactivated by heating at 100° C. for 5 minutes. This reaction solution is designated “reaction solution 2” (reaction 2). Further, an N-acetylglucosaminyltransferase (β3GnT2) and a glycosyl donor substrate (UDP-GlcNAc) in the volumes shown in Table 2C were added to reaction solution 2, and the mixture was reacted at 37° C. for 2 hours. After confirming that the reaction has proceeded to about 50% as monitored by Reflex IV, the reaction was stopped by heating at 100° C. for 5 minutes. This reaction solution is designated “reaction solution 3” (reaction 3). Then, a galactosyltransferase (β4GalT1) and a glycosyl donor substrate (UDP-Gal) in the volumes shown in Table 2D were added to reaction solution 3, and the mixture was reacted at 25° C. for 1 hour while the reaction was monitored by Reflex IV. When the reaction proceeded to about 50%, the reaction was stopped by heating at 100° C. for 5 minutes. This reaction solution is designated “reaction solution 4” (reaction 4).

| | |
|---|---|
| ST3Gal IV | 5 |
| Acceptor (100 μM) | 10 |
| HEPES (500 mM, pH 7.0) | 4 |
| MnCl₂ (200 mM) | 2 |
| CMP-Neu5Ac | 1 |
| H₂O | 18 |
| | Total 40 μl |
| FUT6 | 2 |
| Reaction Solution 1 | 40 |
| HEPES (500 mM, pH 7.0) | 0 |
| MnCl₂ (200 mM) | 0 |
| GDP-Fuc (1 mM) | 1 |
| | Total 43 μl |
| β3GnT2 | 1 |
| Reaction Solution 2 | 43 |
| HEPES (500 mM, pH 7.0) | 0 |
| MnCl₂ (200 mM) | 0 |
| UDP-GlcNAc (1 mM) | 1 |
| | Total 45 μl |
| β4GalT1 | 1 |
| Reaction Solution 3 | 45 |
| HEPES (500 mM, pH 7.0) | 0 |
| MnCl₂ (200 mM) | 0 |
| UDP-GlcNAc (500 μM) | 1 |
| | Total 47 μl |

The results of reaction solutions 1-4 after stopping each reaction as monitored by Reflex IV are shown in FIG. 1. In the figure, solid circles represent N-acetylgalactosamine, open circles represent galactose, solid squares represent N-acetylglucosamine, open triangles represent fucose, and open stars represent N-acetylneuraminic acid. After completion of reaction 4, the enzyme bound to the agarose gel contained in the reaction solution was removed by filtration to prepare an oligosaccharide library containing six compounds.

When various glycosyltransferases were used in the order of reactions 1-4, two oligosaccharides as shown in scheme 3 (indicated by crosses), i.e., GlcNAcβ1-3Galβ1-4(Fucα1-3)GlcNAcβ1-6(Galβ1-3)GalNAcα1-, and Galβ1-4GlcNAcβ1-3Galβ1-4(Fucα1-3)GlcNAcβ1-6(Galβ1-3)GalNAcα1- were not obtained (FIG. 1).

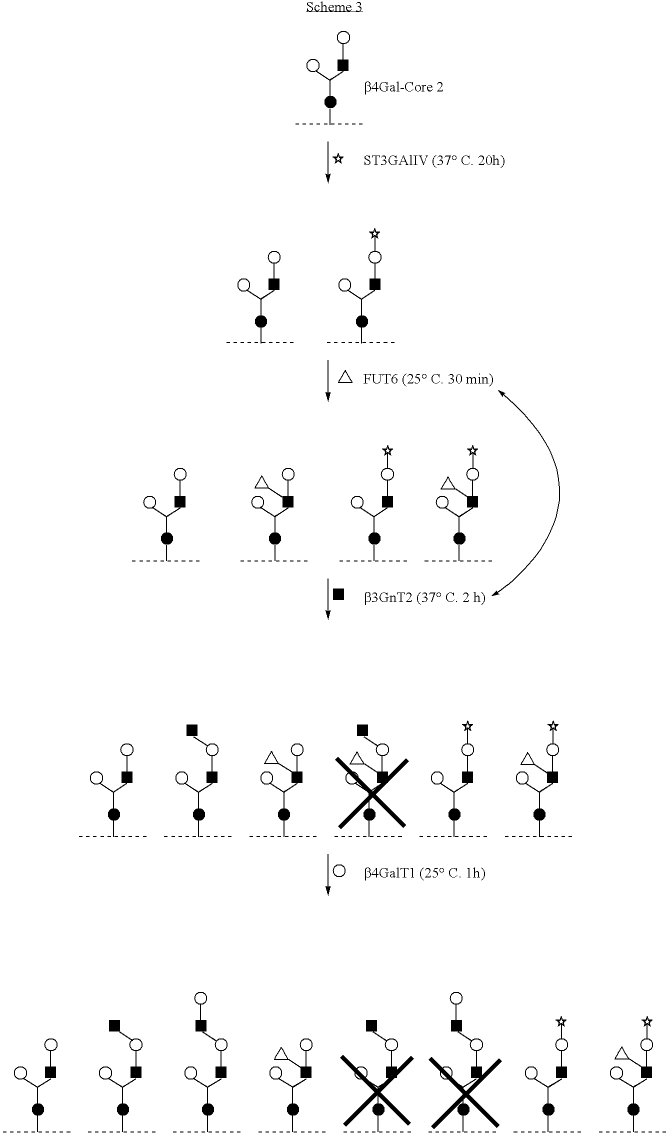

This result suggests that the transfer of N-acetylglucosamine by the N-acetylglucosaminyltransferase (reaction 3) was blocked by the presence of the fucose residue attached to the N-acetylglucosamine residue. Thus, an oligosaccharide library not having a specific oligosaccharide structure could be constructed by the combination and the order of addition of enzymes described above.

For the purpose of obtaining an oligosaccharide library containing the two oligosaccharides that were not obtained by the order of reactions described above, similar transfer reactions were performed with the order of addition of glycosyltransferases changed. A solution containing a sialyltransferase (ST3Gal IV), a glycosyl acceptor substrate (β4Gal-core 2-Muc1a), a glycosyl donor substrate (CMP-Neu5Ac), a divalent cation, a buffer and others in the volumes shown in Table 3A below was reacted at 37° C. for 20 hours while the reaction was monitored by Reflex IV in the same manner as described above, and at the point when the reaction proceeded to about 50%, the reaction was stopped by heat treatment. This reaction solution is designated “reaction solution 1′” (reaction 1′). Then, an N-acetylglucosaminyltransferase (β3GnT2) and a glycosyl donor substrate (UDP-GlcNAc) in the volumes shown in Table 3B were added, and the mixture was reacted at 37° C. for 2 hours, and at the point when the reaction proceeded to about 50%, the reaction was stopped in the same manner. This reaction solution is designated “reaction solution 2′” (reaction 2′). Further, a fucosyltransferase (FUT6) and a glycosyl donor substrate (GDP-Fuc) in the volumes shown in Table 3C were added, and the mixture was reacted at 25° C. for 30 minutes, after which the reaction was stopped by heat treatment. This reaction solution is designated “reaction solution 3′” (reaction 3′). Then, a galactosyltransferase (β4GalT1) and a glycosyl donor substrate (UDP-Gal) in the volumes shown in Table 3D were added, and the mixture was reacted at 25° C. for 2 hours, after which the reaction was stopped by heat treatment. This reaction solution is designated “reaction solution 4” (reaction 4′).

| | |
|---|---|
| ST3Gal IV | 5 |
| Acceptor (100 μM) | 10 |
| HEPES (500 mM, pH 7.0) | 4 |
| MnCl₂ (200 mM) | 2 |
| CMP-Neu5Ac (50 mM) | 2 |
| H₂O | 18 |
| | Total 40 μl |
| β3GnT2 | 2 |
| Reaction Solution 1 | 40 |
| HEPES (500 mM, pH 7.0) | 0 |
| MnCl₂ (200 mM) | 0 |
| UDP-GlcNAc (1 mM) | 1 |
| | Total 43 μl |
| FUT6 | 1 |
| Reaction Soution 2 | 43 |
| HEPES (500 mM, pH 7.0) | 0 |
| MnCl₂ (200 mM) | 0 |
| GDP-Fuc (1 mM) | 1 |
| | Total 45 μl |
| β4GalT1 | 1 |
| Reaction Solution 3 | 45 |
| HEPES (500 mM, pH 7.0) | 0 |
| MnCl₂ (200 mM) | 0 |
| UDP-Gal (500 μM) | 1 |
| | Total 47 μl |

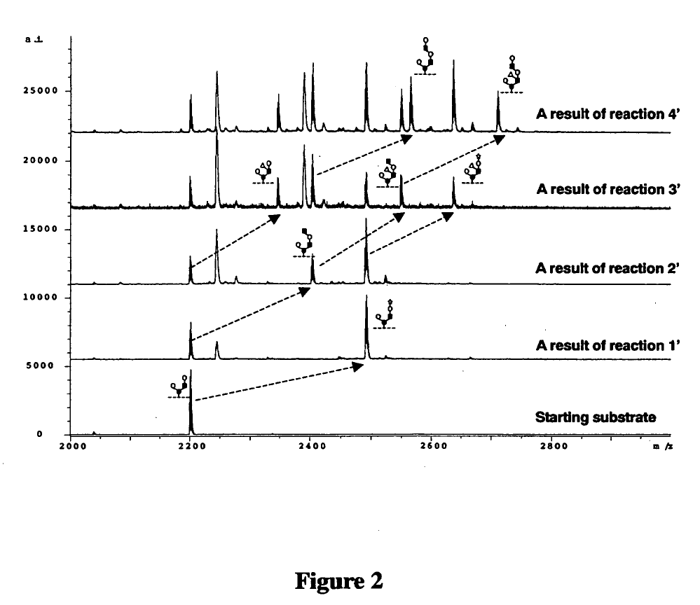

The results of reaction solutions 1′-4′ after stopping each reaction as monitored by Reflex IV are shown in FIG. 2. As shown in FIG. 2 and scheme 1, an oligosaccharide library containing two oligosaccharide structures that were not obtained by reactions 1-4 could be obtained by reactions 1′-4′.

These results show that oligosaccharide libraries having a desired oligosaccharide structure can be constructed by changing the order of glycosyltransferases added. On the other hand, oligosaccharide libraries can also be constructed not to contain a specific oligosaccharide structure.

### Example 2

### Construction of Oligosaccharide Libraries of Polylactosamines

Elongation of polylactosamine chains was performed using Tn-Muc1a as a starting material in the same vessel. N-acetylglucosaminyltransferases (β3GnT6 and β3GnT2), a galactosyltransferase (β4GalT1), a glycosyl acceptor substrate (Tn-Muc1a), and glycosyl donor substrates (UDP-GlcNAc and UDP-Gal) in the volumes shown in Table 4 below were used. β3GnT6 is an enzyme transferring N-acetylglucosamine to the GalNAc residue of Tn antigen via β1-3 linkage, and β3GnT2 is an enzyme transferring N-acetylglucosamine to the galactose residue of lactosamine chains via β1-3 linkage. A solution containing these components as well as a divalent cation, a buffer and others was reacted at 37° C. for 30 hours while the reaction was monitored by Reflex IV in the same manner as in Examples 1 and 2 to show that a mixture containing oligosaccharide structures consisting of Galβ1-4-core 3 structures elongated by mostly 4-11 units of a lactosamine structure (Galβ1-4GlcNAcβ1-3) was successfully obtained in one reaction as monitored by MALDI TOF MS (FIG. 3).

| | |
|---|---|
| β3GnT6 | 10 |
| β3GnT2 | 5 |
| β4GalT1 | 5 |
| Tn-Muclα (500 μM) | 5 |
| HEPES (500 mM, pH 7.0) | 6 |
| MnCl₂ (200 mM) | 3 |
| UDP-GlcNAc (50 mM) | 5 |
| UDP-Gal (50 mM) | 5 |
| H₂O | 16 |
| | Total 60 μl |

### Example 3

### Construction of Oligosaccharide Libraries of Sialylated Polylactosamines

A solution containing an N-acetylglucosaminyltransferase (β3GnT2), a galactosyltransferase (β4GalT1), a glycosyl acceptor substrate (core 3-Muc1a), glycosyl donor substrates (UDP-GlcNAc and UDP-Gal), a divalent cation, a buffer and others in the volumes shown in Table 5A below was reacted at 37° C. for 12 hours. The reaction was monitored by Reflex IV to show that an oligosaccharide library containing oligosaccharide structures having core 3 structure elongated by mostly 1-5 units of a lactosamine structure could be obtained in one reaction. Then, the reaction was stopped by heat treatment. This reaction solution is designated “reaction solution A” (reaction A).

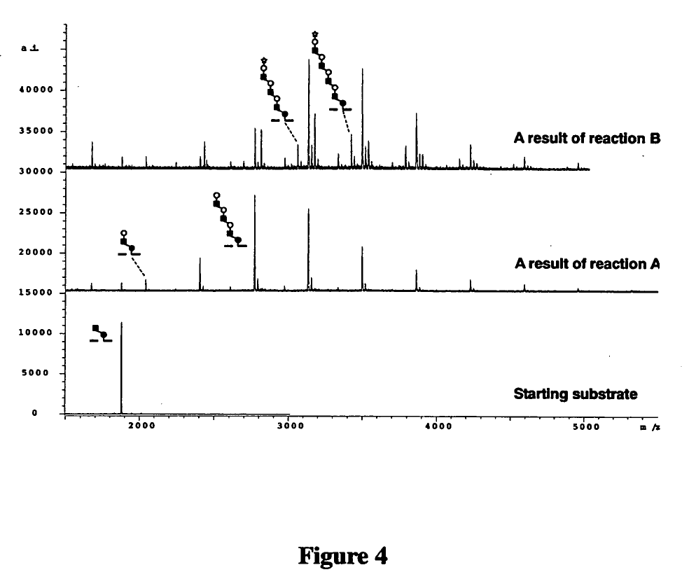

Further, a sialyltransferase (ST3Gal III) and a glycosyl donor substrate (CMP-Neu5Ac) in the volumes shown in Table 5B were added to reaction solution A obtained as above, and the mixture was reacted at 37° C. for 20 hours, and the reaction was stopped by heat reaction (reaction B). The results monitored by Reflex IV are shown in FIG. 4. Thus, an oligosaccharide library of polylactosamine chains sialylated at the reducing end was successfully constructed.

| | |
|---|---|
| β3GnT2 | 5 |
| β4GalT1 | 5 |
| Core3-Muclα (500 μM) | 5 |
| HEPES (500 mM, pH 7.0) | 2 |
| MnCl2 (200 mM) | 2 |
| UDP-GlcNAc (10 mM) | 5 |
| UDP-Gal (10 mM) | 5 |
| H₂O | 11 |
| | Total 40 μl |
| ST3Gal III | 5 |
| Reaction Solution A | 40 |
| HEPES (500 mM, pH 7.0) | 0 |
| MnCl2 (200 mM) | 0 |
| CMP-Neu5Ac (50 mM) | 2 |
| H₂O | 0 |
| | Total 60 μl |

### Example 4

### Construction of Various Oligosaccharide Libraries Having Core 3 Structure

By using core 3 structure as a starting material along with combinations of various glycosyltransferases, various oligosaccharide libraries containing sialyl Lewis A, sialyl Lewis X, antigen A, or antigen B can be constructed as shown in scheme 4 below.

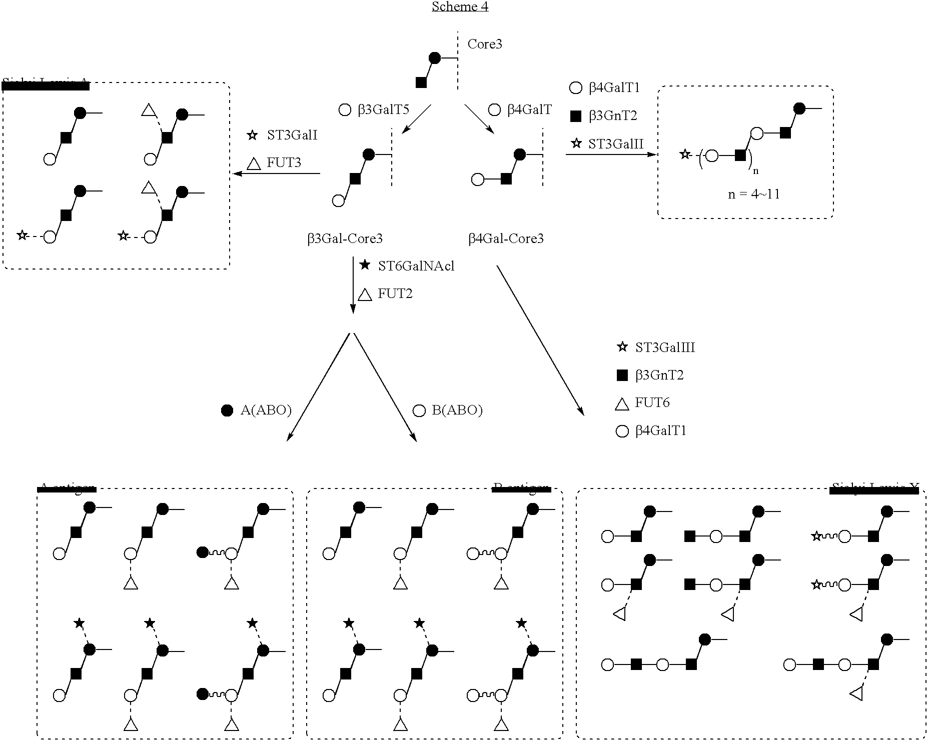

(1) An Oligosaccharide Library Containing Sialyl Lewis A

A galactosyltransferase transferring galactose to the N-acetylglucosamine residue via β1-3 linkage (β3GalT5), a glycosyl acceptor substrate (core 3: GlcNAcβ1-3GalNAcα1-), and a glycosyl donor substrate (UDP-Gal) are reacted for a predetermined period, and the reaction is stopped when the degree of reaction reaches about 100% (reaction 1). This reaction affords Galβ1-3GlcNAcβ1-3GalNAcα1-. This reaction solution is designated “reaction solution a”. Then, a sialyltransferase (ST3Gal I), a fucosyltransferase (FUT3) and glycosyl donor substrates (CMP-Neu5Ac and GDP-Fuc) are added to reaction solution a, and the mixture is reacted for a predetermined period, whereby an oligosaccharide library having four oligosaccharide structures consisting of sialyl Lewis A (Neu5Acα2-3Galβ1-3(Fucα1-4)GlcNAcβ1-3GalNAcα1-) and other three oligosaccharides (Galβ1-3GlcNAcβ1-3GalNAcα1-, Galβ1-3(Fucα1-4)GlcNAcβ1-3GalNAcα1-, Neu5Acα2-3Galβ1-3GlcNAcβ1-3GalNAcα1-) can be constructed (scheme 4).

(2) An Oligosaccharide Library Containing Sialyl Lewis X

A galactosyltransferase transferring galactose to the N-acetylglucosamine residue via β1-4 linkage (β4GalT1), a glycosyl acceptor substrate (core 3: GlcNAcβ1-3GalNAcα1-), and a glycosyl donor substrate (UDP-Gal) are reacted for a predetermined period, and the reaction is stopped when the degree of reaction reaches about 100%. This reaction affords Galβ1-4GlcNAcβ1-3GalNAcα1-. This reaction solution is designated “reaction solution b”. Then, a sialyltransferase (ST3Gal III), an N-acetylglucosaminyltransferase (β3GnT2), a fucosyltransferase (FUT6), a galactosyltransferase (β4GalT1), and glycosyl donor substrates (CMP-Neu5Ac, UDP-GlcNAc, GDP-Fuc, UDP-Gal) are added to reaction solution b, and the mixture is reacted for a predetermined period, whereby an oligosaccharide library having eight oligosaccharide structures consisting of sialyl Lewis X (Neu5Acα2-3Galβ1-4(Fucα1-3)GlcNAcβ1-3GalNAcα1-) and other seven oligosaccharides can be constructed (scheme 4).

(3) An Oligosaccharide Library Containing Antigen A

Reaction solution a prepared in (1) above is reacted with a sialyltransferase (ST6GalNAc I), a fucosyltransferase (FUT2), an N-acetylgalactosaminyltransferase (H-α3GalNAcT), and glycosyl donor substrates (CMP-Neu5Ac, GDP-Fuc, UDP-GalNAc) for a predetermined period, and the reaction is stopped when the degree of reaction reaches about 50%. As a result, an oligosaccharide library containing a total of six oligosaccharides including antigen A (GalNAcα1-3(Fucα1-2)Galβ1-3GlcNAcβ1-3GalNAcα1-) can be constructed (scheme 4).

(4) An Oligosaccharide Library Containing Antigen B

Reaction solution a prepared in (1) above is reacted with a sialyltransferase (ST6GalNAc I), a fucosyltransferase (FUT2), a galactosyltransferase (H-α3GalT), and glycosyl donor substrates (CMP-Neu5Ac, GDP-Fuc, UDP-Gal) for a predetermined period and the reaction is stopped when the degree of reaction reaches about 50%. As a result, an oligosaccharide library containing a total of six oligosaccharides including antigen B (Galα1-3(Fucα1-2)Galβ1-3GlcNAcβ1-3GalNAcα1-) can be constructed (scheme 4).

### INDUSTRIAL APPLICABILITY

Oligosaccharide libraries are established, which can be applied to diagnoses and treatments of various diseases by analyzing interactions between oligosaccharides and oligosaccharide-related molecules and correlations between oligosaccharide structures and their functions.

### REFERENCES

A. Patent Documents

1. International Publication WO03/057887

B. Non-Patent Documents
1. Liang, R. et al., Science, 274, 1520-1522(1996)
2. Kahne, D., Curr. Opin. Chem. Biol., 1, 130-135(1997)
3. Meldal, M., Methods Enzymol., 289, 83-104(1997)
4. Hilaire, P. M. et al., Angew. Chem. Int. Ed. Engl., 39, 1162-1179(2000)
5. Kanie, O., et al., Angew. Chem. Int. Ed. Engl., 34, 2720-2721(1995)
6. Ding, U., et al., Bioorg. Med. Chem., 4, 683-692(1996)
7. Wong, C. H. et al., J. Am. Chem. Soc., 120, 7137-7138(1998)
8. Zhang, Z. et al., J. Am. Chem. Soc., 121, 734-753(1999)
9. Takahashi, T., et al., Tetrahedron Lett., 41, 2599-2603(2000)
10. Sato, T., et al., “Proteins, Nucleic Acids, Enzymes”, Vol. 48, pp. 1213-1219(2003)
11. Cheng, L. et al., FEBS Lett., 531, 115-121(2002)
12. Guo, J. M. et al., FEBS Lett., 524, 211-218(2002)
13. Zhang, Y. et al., J. Biol. Chem., 278, 573-584(2003)
14. Wang, H. et al., Biochem. Biophys. Res. Commun., 300, 738-744(2003)
15. Cheng, L. et al., FEBS Lett., 566, 17-24(2004)
16. Gotoh, M. et al., J. Biol. Chem., 277, 38179-38188(2002)(1)
17. Gotoh, M. et al., J. Biol. Chem., 277, 38189-38196(2002)(2)
18. Sato, T. et al., J. Biol. Chem., 278, 3063-3071(2003)
19. Sato, T. et al., J. Biol. Chem., 278, 47534-47544(2003)
20. Yada, T. et al., J. Biol. Chem., 278, 30235-30247(2003)
21. Yada, T. et al., J. Biol. Chem., 278, 39711-39725(2003)
22. Gotoh, M. et al., FEBS Lett., 562, 134-140(2004)
23. Isshiki, S. et al., J. Biol. Chem., 274, 12499-12507(1999)
24. Shiraishi, N. et al., J. Biol. Chem., 276, 3498-3507(2001)
25. Togayachi, A. et al., 276, 22032-22040(2001)
26. Mochizuki, H. et al., 278, 26780-26787(2003)
27. Gindzienski, A. et al., Eur. J. Biochem. 43, 155-160(1974)
28. Hinderlich, S. et al., Eur. J. Biochem., 267, 3301-3308(2000)
29. Haritos, A. A. et al., Biochim. Biophys. Acta., 873, 335-339(1986)
30. Shi, W. X. et al., Glycobiology, 8, 199-205(1998)
31. Shen, Y. et al., 383, 307-317(2002)

1. A process for preparing a compound library in the same vessel, comprising:
(1) mixing one or more donor substrates, acceptor substrates, and transferases;
(2) performing a transfer reaction to reach a degree of transfer of 1%-99% by incubating the mixture; and
(3) stopping the transfer reaction.

2. The process for preparing a compound library of claim 1 wherein the degree of transfer is measured by a mass spectrometer.

3. The process for preparing a compound library of claim 1 wherein step (1) comprises adding the donor substrate and the transferase to the acceptor substrate.

4. The process for preparing a compound library of claim 3, further comprising the step of adding the same or different donor substrate and transferase to the product of the transfer reaction and repeating one or more cycles of steps (1)-(3).

5. The process for preparing a compound library of claim 4 wherein the number of cycles of steps (1)-(3) is 1-10.

6. The process for preparing a compound library of claim 5 wherein the reaction is stopped when the degree of transfer reaches 50%.

7. The process for preparing a compound library of claim 1 wherein the transferase is an N-acetylneuraminyltransferase, fucosyltransferase, N-acetylglucosaminyltransferase, N-acetylgalactosaminyltransferase, galactosyltransferase, glucosyltransferase, glucuronyltransferase, mannosyltransferase, xylosyltransferase, sulfotransferase, phosphotransferase, or acyltransferase.

8. The process for preparing a compound library of claim 1 wherein the acceptor substrate is a glycosyl acceptor substrate, peptide, protein or lipid or a modified form thereof or a mixture thereof.

9. The process for preparing a compound library of claim 8 wherein the glycosyl acceptor substrate is a monosaccharide, oligosaccharide, glycopeptide, glycoprotein, or glycolipid.

10. The process for preparing a compound library of claim 9 wherein the oligosaccharide, glycopeptide, glycoprotein, or glycolipid has an oligosaccharide structure selected from the group consisting of Tn antigen, core 2 structure, core 3 structure, core 4 structure, core 5 structure, core 7 structure, and core 8 structure.

11. The process for preparing a compound library of claim 1 wherein the donor substrate is selected from the group consisting of sugar nucleotides, dolichol phosphate-sugars, 3′-phosphoadenosine 5′-phosphosulfate (PAPS), adenosine triphosphate (ATP), and acetyl-CoA.

12. A compound library prepared by the process of claim 1.

13. The compound library of claim 12 wherein the structure of each component of the compound library is identified from its molecular weight.

14. A chip using the compound library of claim 12.
